(19) United States
(12) Patent Application Publication
(10) Pub. No.: US 2012/0105010 A1
(43) Pub. Date: May 3, 2012

(54) LITHIUM ION SECONDARY BATTERY SYSTEM AND BATTERY PACK

(76) Inventor: Masahiro Kinoshita, Osaka (JP)

(21) Appl. No.: 13/382,713

(22) PCT Filed: Mar. 16, 2011
(86) PCT No.: PCT/JP2011/001545

§ 371 Date: Jan. 6, 2012

(30) Foreign Application Priority Data
May 17, 2010 (JP) 2010-112876

(51) Int. Cl. H02J 7/00

(52) U.S. Cl. 320/136

(57) ABSTRACT

A lithium ion secondary battery system includes: an assembled battery including a plurality of lithium ion secondary batteries; a SOC measuring unit for measuring the SOC of the lithium ion secondary battery, and a temperature sensing unit for sensing the temperature thereof; and a heating unit for heating the lithium ion secondary battery. When a SOC measured by the SOC measuring unit is lower than a preset SOC set in advance in association with discharge rate, and a temperature measured by the temperature sensing unit is lower than a preset temperature set in advance in association with discharge rate, then, a control unit sends a command to the heating unit to supply heat, so that the temperature of the lithium ion secondary battery becomes a predetermined temperature.

### RELATED APPLICATIONS

This application is the U.S. National Phase under 35 U.S.C. §371 of International Application No. PCT/JP2011/001545, filed on Mar. 16, 2011, which in turn claims the benefit of Japanese Application No. 2010-112876, filed on May 17, 2010, the disclosures of which Applications are incorporated by reference herein.

### TECHNICAL FIELD

The present invention relates to improving discharge control in a battery system using lithium ion secondary batteries including olivine-based lithium composite phosphate as a positive electrode active material.

### BACKGROUND ART

Discharge capacity of a lithium ion secondary battery is known to change depending on the temperature thereof during discharge. Specifically, for example, in the case of a constant discharge current, at the same state of charge (SOC), the lower the ambient temperature during discharge, the greater the drop in discharge voltage. As a result, the predetermined discharge cutoff voltage is reached too soon, and therefore, the discharge capacity becomes smaller. Such drop in discharge voltage at low temperatures is caused, because in a low-temperature environment, reduced mobility of lithium ions causes greater polarization, and this causes a rise in internal resistance of the battery and thus a drop in voltage.

For suppression of decrease in discharge capacity caused at low ambient temperatures as described above, PTL 1 and PTL 2 disclose a technique by which decrease in battery capacity is suppressed in the manner of sensing the temperature of a battery in use, and heating the battery, in the case where the sensed temperature is lower than the temperature set in advance. Further, as an alternative, attempts are also being made to secure as much discharge capacity as possible, by setting a low discharge cutoff voltage to cause delay in reaching the discharge cutoff voltage.

### CITATION LIST

### Patent Literatures

[PTL 1] Japanese Laid-Open Patent Publication No. Hei 11-25948
[PTL 2] Japanese Laid-Open Patent Publication No. 2006-196256

### SUMMARY OF INVENTION

### Technical Problem

Anticipated is the practical use of lithium ion secondary batteries (hereinafter referred to as olivine-based lithium ion batteries) using a positive electrode active material based on olivine-based lithium composite phosphate, being excellent in thermal stability, as an alternative to lithium ion secondary batteries (hereinafter referred to as cobalt oxide-based lithium ion batteries) using a positive electrode active material based on lithium cobalt oxide, having been conventionally and widely put into practical use as a positive electrode active material in lithium ion secondary batteries.

However, as with a cobalt oxide-based lithium ion battery, an olivine-based lithium ion battery also exhibits a drop in discharge voltage when the ambient temperature during discharge becomes low, and thus exhibits a decrease in discharge capacity. Therefore, considered effective is a technique as that disclosed in PTL 1 and PTL 2, by which, in the case of low ambient temperatures, decrease in battery capacity is suppressed in the manner of sensing the temperature of a battery in use, and heating the battery in the case where the sensed temperature is lower than the temperature set in advance. In the alternative, it is also considered effective to set a low discharge cutoff voltage to cause delay in reaching the discharge cutoff voltage.

However, with respect to olivine-based lithium ion batteries, there is the problem of deterioration being easily promoted in the positive electrode active material, when a battery having a high SOC is heated. In the case where a low discharge cutoff voltage is set, there is the problem of deterioration being easily promoted in the positive electrode active material due to elution of metal components such as iron and manganese contained in the positive electrode active material.

The present invention aims to provide a lithium ion secondary battery system and a battery pack, being capable of: suppressing deterioration of lithium ion secondary batteries having a positive electrode which includes olivine-based lithium composite phosphate; and securing the discharge capacity thereof.

### Solution to Problem

One aspect of the present invention relates to a lithium ion secondary battery system comprising: an assembled battery including a plurality of lithium ion secondary batteries each provided with a positive electrode including olivine-based lithium composite phosphate; a SOC measuring unit for measuring the SOC, which indicates the state of charge, of at least one of the lithium ion secondary batteries; a temperature sensing unit for sensing the temperature of at least one of the lithium ion secondary batteries; a heating unit for heating at least one of the lithium ion secondary batteries; and a heating control unit for controlling the heating unit to heat the at least one of the lithium ion secondary batteries. The heating control unit sends a command to heat the at least one of the lithium ion secondary batteries to a predetermined target temperature, when a SOC measured by the SOC measuring unit is lower than a preset SOC set in advance in association with discharge rate, and a temperature sensed by the temperature sensing unit is lower than a preset temperature set in advance in association with the discharge rate.

Another aspect of the present invention relates to a battery pack comprising: the aforementioned lithium ion secondary battery system; and a charge/discharge control unit for controlling charge and discharge of the plurality of the lithium ion secondary batteries.

### Advantageous Effects of Invention

According to the present invention, in a lithium ion secondary battery having a positive electrode which includes olivine-based lithium composite phosphate, deterioration of the positive electrode active material caused by unnecessary heating can be suppressed, since the battery is heated only at the final stage of discharge where the SOC is lower than the preset SOC set in advance.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A block diagram showing a schematic configuration of a lithium ion secondary battery system according to an embodiment of the present invention.

FIG. 2 A flowchart showing a control method in the lithium ion secondary battery system of FIG. 1.

FIG. 3 A block diagram showing a modified version of the schematic configuration of the lithium ion secondary battery system of FIG. 1.

FIG. 4 A graph showing discharge characteristic curves for a lithium ion secondary battery using olivine-based lithium composite phosphate as a positive electrode active material.

### DESCRIPTION OF EMBODIMENTS

The present inventor conducted detailed studies on temperature dependence and discharge-rate dependence of discharge characteristic curves for an olivine-based lithium ion battery. As a result, it was found that an olivine-based lithium ion battery differed from a cobalt oxide-based lithium ion battery in discharge behavior, and required a different approach for controlling the state of discharge, from that for a cobalt oxide-based lithium ion battery.

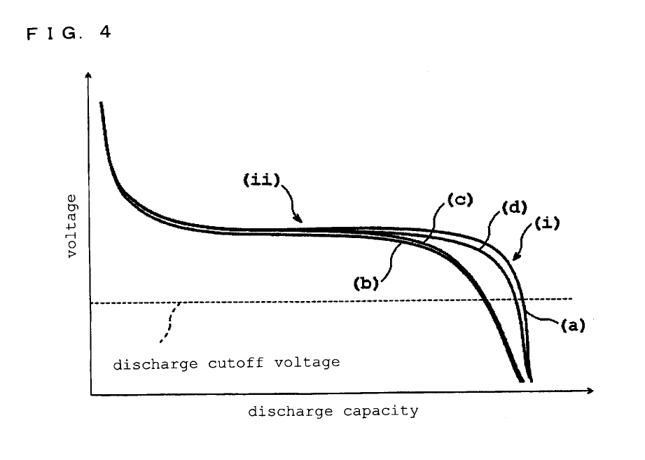

FIG. 4 shows discharge characteristic curves when there are changes to the ambient temperature and discharge rate, for a lithium ion secondary battery using olivine-based lithium composite phosphate as a positive electrode active material. In FIG. 4: (a) is a characteristic curve for discharge carried out at a low rate (0.2 C) in a room-temperature environment (25° C.); (b) is a characteristic curve for discharge carried out at a low rate in a low-temperature environment (0° C.); (c) is a characteristic curve for discharge carried out at a high rate (2 C) in a room-temperature environment; and (d) is a characteristic curve for discharge carried out at a high rate in a high-temperature environment.

As evident from these characteristic curves, the discharge voltage of an olivine-based lithium ion battery drops rapidly at the final stage of discharge where the SOC decreases. However, from the initial stage to intermediate stage of discharge where there is no decrease in the SOC, dependency of the discharge voltage on ambient temperature is low. Thus, when the battery is discharged only to a slight extent and has a high SOC, not only is there little advantage in heating the battery, but by heating the battery, there are great disadvantages such as deterioration promoted in electrode material and unnecessary consumption of energy. On the other hand, a comparison between curves (a) and (c) makes evident that in a region where the SOC is low, dependency of the discharge voltage on discharge rate is high. Specifically, in a region where the SOC is low, there is a remarkable drop in the discharge voltage when high-rate discharge is carried out. Similarly, a comparison between curves (a) and (b) and a comparison between curves (c) and (d) make evident that in a region where the SOC is low, dependency of the discharge voltage on ambient temperature is high.

From the results of studies related to the discharge curves as above, the present inventor was able to complete the present invention by finding out that: from the initial stage to intermediate stage of discharge where there is no decrease in the SOC, the effect of improved capacity due to heating the battery is not high, since dependency of the discharge voltage on ambient temperature is low; and at the final stage of discharge where the SOC is low, dependency of the battery capacity on ambient temperature and discharge rate is remarkable.

A lithium ion secondary battery system which is an embodiment of the present invention, comprises: an assembled battery including a plurality of lithium ion secondary batteries each provided with a positive electrode including olivine-based lithium composite phosphate; a SOC measuring unit for measuring the SOC (State of Charge) which indicates the state of charge of the lithium ion secondary battery; a temperature sensing unit for sensing the temperature of the lithium ion secondary battery; a heating unit for heating the lithium ion secondary battery; and a heating control unit for controlling the heating unit to heat the lithium ion secondary battery. The heating control unit sends a command to heat the lithium ion secondary battery to a predetermined target temperature, when a SOC measured by the SOC measuring unit is lower than a preset SOC set in advance in association with discharge rate, and a temperature sensed by the temperature sensing unit is lower than a preset temperature set in advance in association with the discharge rate.

The SOC measuring unit and the temperature sensing unit are acceptable, as long as they measure the SOC and the temperature, respectively, for at least one among the plurality of the lithium ion secondary batteries. Further, in the case where the temperature sensing unit detects the temperatures of two or more of the lithium ion secondary batteries, it may detect the temperatures of these batteries individually, or may detect the average temperature of these batteries. Similarly, in the case where the SOC measuring unit detects the SOCs of two or more of the lithium ion secondary batteries, it may detect the SOCs of these batteries individually, or may detect the average SOC of these batteries. Even in the case where the SOCs are detected individually, one SOC may be detected per group, if there are group(s) of batteries having the same SOC.

The heating unit and the heating control unit are acceptable, as along as they heat and control heating, respectively, for at least one among the plurality of the lithium ion secondary batteries. In the case where the heating unit heats two or more of the lithium ion secondary batteries, it may heat these batteries individually or in total. With respect to the heating control unit, in the case where the heating unit heats two or more of the lithium ion secondary batteries individually, it preferably controls the heating of each of these batteries individually. On the other hand, in the case where the heating unit heats two or more of the lithium ion secondary batteries in total, it may only control the heating of these batteries in total.

In the aforementioned lithium ion secondary battery system, heating of the lithium ion secondary battery is carried out, only in the case where the measured SOC is lower than the preset SOC set in advance depending on discharge rate, and the detected temperature is lower than the preset temperature set in advance depending on discharge rate. In other words, heating is not carried out when the measured SOC of the lithium ion secondary battery is higher than the preset SOC. Therefore, since the lithium ion secondary battery is heated only when the SOC is low at the final stage of discharge, battery capacity can be improved while suppressing deterioration of the olivine-based lithium composite phosphate caused by heating. Further, heating which does not contribute much to improving battery capacity is eliminated, and this enables prevention of unnecessary consumption of energy. Note that the preset SOC and the preset temperature are set in advance in association with, for example, the discharge rate required by a loading device (external equipment) connected to the lithium ion secondary battery system.

In terms of suppressing capacity degradation in the olivine-based lithium composite phosphate caused by a high SOC and a high temperature, it is preferable: to set the preset SOC within the range of 5 to 40% relative to a 100% SOC which indicates a fully-charged state of the lithium ion secondary battery; and to set the preset temperature within the range of 25 to 50° C. In terms of suppressing deformation of the separator, etc. due to overheating, it is preferable to set the target temperature within the range of 45 to 55° C.

In terms of improving capacity, the olivine-based lithium composite phosphate is represented by the general formula (I): LiₓMe(PO_{y})_{z}, where Me is at least one element selected from the group consisting of Na, Mg, Sc, Y, Mn, Fe, Co, Ni, Cu, Zn, Al, Cr, Pb, Sb, and B; 0<x≦2; 3≦y≦4; and 0.5<z≦1.5. It is preferable that Me includes two or more elements, and 20 mol % or more of Me is Fe.

For the heating unit, means for heating such as a resistor which generates heat due to passing of current; a heating device which utilizes induction heating; and a heating device which utilizes an external heat source, can be used. In the case where the aforementioned lithium ion secondary battery is installed as a power source for driving a vehicle, residual heat caused by driving the vehicle is particularly preferably used as an external heat source, in terms of improving energy efficiency. In the alternative, the abovementioned means for heating can be used in a combination. In particular, it is preferable that the heating by an external heat source is made primary, and is supplemented by the heating by a resistor which generates heat due to passing of current, or by other means of heating.

The aforementioned lithium ion secondary battery system can be realized as a battery pack which is integrated together with a charge/discharge control unit for controlling charge and discharge of the lithium ion secondary batteries. In the alternative, the system may be realized in the manner of making the heating control unit independent, and having it incorporated into an electric control unit (ECU) which includes the charge/discharge control unit; and then having the ECU incorporated into, for example, a loading device.

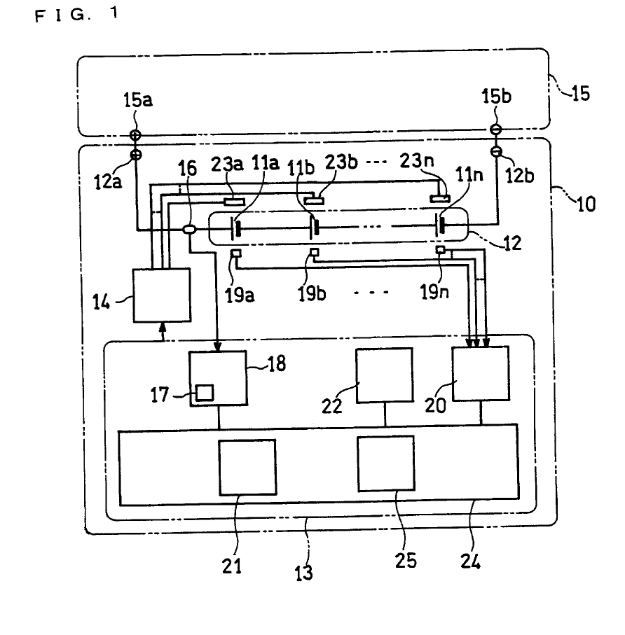

In the following, a detailed description will be given on an embodiment of the lithium ion secondary battery system according to the present invention, with reference to a battery pack 10 shown in FIG. 1.

The battery pack 10 comprises: an assembled battery 12 including a plurality of lithium ion secondary batteries 11 (11a, 11b, . . . , 11n); a battery control unit 13; and a heating unit for heating the lithium ion secondary batteries 11. These are accommodated, for example, inside a housing (not shown) made of resin. The assembled battery 12 is electrically connected to: a connection terminal 12a on the positive electrode side; and a connection terminal 12b on the negative electrode side, both extending out from the housing of the assembled battery 12. The connection terminal 12a and the connection terminal 12b are connected to: a connection terminal 15a on the positive electrode side; and a connection terminal 15b on the negative electrode side, respectively, of a loading device 15. Typically, for the loading device 15, a motor for driving hybrid cars, electric vehicles, or the like can be used. In the alternative, a laptop computer, or an electronic device such as a cell phone, can also be used.

The connection terminal 12a and the connection terminal 12b are connected to the assembled battery 12, via a switching device or switching circuit for discharge (not shown) and a switching device or switching circuit for charge (not shown), respectively. Further, in the case where the switching device for discharge is ON, power is supplied to the loading device 15 due to flow of current from the assembled battery 12 to a discharge circuit (not shown). On the other hand, in the case where the switching device for charge is ON, the assembled battery 12 is charged with power supplied from an external source.

The battery control unit 13 includes a charge/discharge control unit for controlling the switching device for charge and the switching device for discharge, so that the voltages of the lithium ion secondary batteries 11 in the assembled battery 12 do not exceed the predetermined charge cutoff voltage during charge, and also do not drop below the predetermined discharge cutoff voltage during discharge. Note that, with respect to the battery pack 10 which is shown, the assembled battery 12 and the battery control unit 13 are accommodated inside the housing of the battery pack 10 in an integrated manner. However, the battery control unit may be incorporated inside the loading device 15, as an electric control unit which is independent from the battery pack.

The lithium ion secondary battery 11 comprises a positive electrode which includes olivine-based lithium composite phosphate serving as a positive electrode active material. An example of the olivine-based lithium composite phosphate is a compound represented by the general formula (I): LiₓMe(PO_{y})_{z}, where Me is at least one element selected from the group consisting of Na, Mg, Sc, Y, Mn, Fe, Co, Ni, Cu, Zn, Al, Cr, Pb, Sb, and B; 0<x≦2; 3≦y≦4; and 0.5<z≦1.5.

In the general formula (I), x indicates the atomic ratio of Li, and varies depending on charge and discharge. Its range of variation is 0<x≦2. On the other hand, a preferred range for x when the battery immediately after production and thus in a non-charged state, is 0.9≦x≦1.2. Among the elements represented by Me, Fe is particularly preferred. In the case where Me represents two or more elements, it is preferable that 20 mol % or more of the total elements represented by Me, is Fe. The range for y is 3≦y≦4, preferably 3.8≦y≦4. The range for z is 0.5<z≦1.5, preferably 0.9≦z≦1.1. Among what is given above, LiₓFePO₄ (0<x≦2) is particularly preferred as the olivine-based lithium composite phosphate.

The lithium ion secondary battery 11 has the feature of containing the olivine-based lithium composite phosphate serving as the positive electrode active material. Other components therein are not particularly limited.

The assembled battery 12 includes the plurality of the lithium ion secondary batteries 11a, 11b, . . . , 11n connected in series. The assembled battery may be such including the plurality of the lithium ion secondary batteries connected in parallel, or connected in both series and parallel.

The battery control unit 13 includes: a SOC measuring unit for measuring the SOC of the lithium ion secondary batteries 11; a temperature sensing unit for sensing the temperatures of the lithium ion secondary batteries 11; a heating control unit 21 for controlling heating, carried out by the heating unit, of the lithium ion secondary batteries 11; and a memory unit 22 for storing data necessary for control by the heating control unit 21.

The SOC measuring unit includes: a timer 17; a current sensor 16 for sensing current which flows through the lithium ion secondary batteries 11 in the assembled battery 12; and a SOC calculating unit 18 for calculating the SOC of the lithium ion secondary batteries 11, based on output signals from the current sensor 16. In the assembled battery 12 which is shown, all of the lithium ion secondary batteries 11 are connected in series. Therefore, the number of the current sensor 16 disposed on the line connecting the assembled battery 12 and the terminal 12a, is only one. In the case where there are parallel connection(s) inside the assembled battery 12, it may become necessary to dispose a plurality of the current sensors 16 for sensing the currents of the batteries, per group, which are in a parallel connection.

The SOC calculating unit 18 calculates the SOC (%) of the lithium ion secondary battery 11 by calculating the cumulative discharge current from the start of discharge, with use of the value of the discharge current sensed by the current sensor 16 and the discharge time measured by the timer 7, and then calculating the remaining capacity; and then dividing the remaining capacity [mAh] thus calculated, by the capacity [mAh] of the battery in a fully-charged state. Note that it is preferable to periodically measure the open circuit voltage (OCV) of the lithium ion secondary battery 11 and to periodically correct any error in the SOC which is calculated. The current sensor 16 is, for example, a current sensing resistor, and converts the discharge current to voltage for it to be sensed. The SOC data of the lithium ion secondary battery 11 resulting from the measurement by the SOC calculating unit 18, is stored in the memory unit 22.

The temperature sensing unit includes: a plurality of temperature sensors 19a, 19b, . . . , 19n which are disposed on the surface of, or in the proximity of, the lithium ion secondary batteries 11, respectively; and a temperature calculating unit 20 for calculating the temperature of the lithium ion secondary battery 11 based on output signals from the temperature sensors. The temperature data of the lithium ion secondary battery 11 calculated by the temperature calculating unit 20, is stored in the memory unit 22.

The heating unit heats the lithium ion secondary batteries 11, after receiving a command to heat them from the heating control unit 21. The heating unit includes: a plurality of heaters 23 (23a, 23b, 23n) which are, for example, resistors which generate heat due to passing of current; and a heater drive unit 14 for supplying a predetermined current to the heaters 23. With respect to the heaters: one may be disposed per the lithium ion secondary battery 11, corresponding to the number of the lithium ion secondary batteries 11 present; one may be disposed per a plurality of the lithium ion secondary batteries 11; or they may be disposed for the lithium ion secondary batteries 11 which are specifically selected. To pass currents to the heaters 23, power from the lithium ion secondary batteries 11 can be used. The heating unit is not limited to the heaters 23 for which resistors are used, and can be various heating devices, one such device being that utilizing induction heating. Similarly, also with respect to the temperature sensors: one may be disposed per the lithium ion secondary battery 11, corresponding to the number of the lithium ion secondary batteries 11 present; one may be disposed per a plurality of the lithium ion secondary batteries 11; or they may be disposed for the lithium ion secondary batteries 11 which are specifically selected.

The heating control unit 21 is included in a control unit 24. The control unit 24 is, for example, a control circuit provided with an integrated circuit. The control unit 24 includes the heating control unit 21 and a determining unit 25.

The determining unit 25 takes out the data of the measured SOC and the data of the sensed temperatures, which are stored in the memory unit 22. The data taken out are compared with the target SOC being the preset SOC set in advance in association with discharge rate, and the target temperature being the preset temperature set in advance in association with the discharge rate. Specifically, the comparisons are used to determine whether or not the measured SOC is lower than the preset SOC; and whether or not the sensed temperatures are lower than the preset temperature. In the case where the determining unit 25 determines that the measured SOC is lower than the preset SOC, and that the sensed temperatures are lower than the preset temperature, then, the heating control unit 21 sends a command to heat the lithium ion secondary batteries 11 to a predetermined target temperature.

The preset SOC is set within the range of 5 to 40% relative to a 100% SOC which indicates a fully-charged state. Herein, a fully-charged state means the state in which the battery is charged up to the upper limit of the nominal capacity. On the other hand, a totally-discharged state of a 0% SOC means the state in which the battery is discharged down to the lower limit of the nominal capacity. For example, in the case where the composition of the positive electrode active material is represented by the aforementioned general formula (I): LiₓMe (PO_{y})_{z}, x is usually about 0.03 when the battery is in a fully-charged state.

The preset SOC is set in advance within the range of 5 to 40% based on test data and design information, depending on the discharge rate of the lithium ion secondary battery 11. For example, the preset SOC is set low when the discharge rate is low (low-rate discharge), and high, when the discharge rate is high (high-rate discharge). More specifically, the preset SOC is preferably 5 to 30% in the case where the discharge rate of the lithium ion secondary battery 11 is 0.1 to 1 C, and preferably 35 to 400, in the case where the discharge rate thereof is 5 to 10 C. Herein, 1 C is the value of the current when discharging a quantity of electricity equivalent to the nominal capacity, in one hour. For example, when the nominal capacity is 1 Ah, 0.1 to 1 C corresponds to 0.1 to 1 A, and 5 to 10 C corresponds to 5 to 10 A.

Moreover, although not limited to the following, the preset SOC can be determined based on the discharge characteristics of the lithium ion secondary battery 11 measured in advance at a predetermined discharge rate, as follows. First, the voltage when the SOC is 50% at a predetermined discharge rate, is designated as a reference voltage. Next, the SOC at the point when the voltage of the lithium ion secondary battery 11 drops 0.05 to 0.1 V (just about 0.1 V) from the reference voltage, is obtained. The value of the SOC thus obtained is designated as the preset SOC at the discharge rate.

Moreover, the preset temperature is set in advance within the range of 25 to 50° C., preferably 30 to 50° C., based on test data and design information, depending on the discharge rate. For example, the preset temperature is set relatively low for low-rate discharge and relatively high for high-rate discharge. More specifically, the preset temperature is preferably 30 to 35° C. in the case where the discharge rate of the lithium ion secondary battery 11 is 0.1 to 1 C, and preferably 40 to 50° C. in the case where the discharge rate thereof is 5 to 10 C. Further, although not limited to the following, the preset temperature is preferably set in advance depending on the discharge rate, so that a discharge capacity which is about the same as that of a reference discharge capacity is obtained, the reference discharge capacity being, for example, a discharge capacity of the lithium ion secondary battery 11 at a discharge rate of 0.1 C and a temperature of 30° C.

Subsequently, the heating unit heats the lithium ion secondary batteries 11. The heating control unit 21 sends to the heating unit a command to stop heating, in the case where it determines that the sensed temperatures of the lithium ion secondary batteries 11 have each reached the predetermined target temperature, such determining being based on data from the temperature calculating unit 20 which are received when the lithium ion secondary batteries 11 have been heated by the heating unit for a certain amount of time. As such, the heating control unit 21 controls heating carried out by the heating unit.

The target temperature for the lithium ion secondary battery 11 is, for example, preferably within the range of 45 to 55° C.

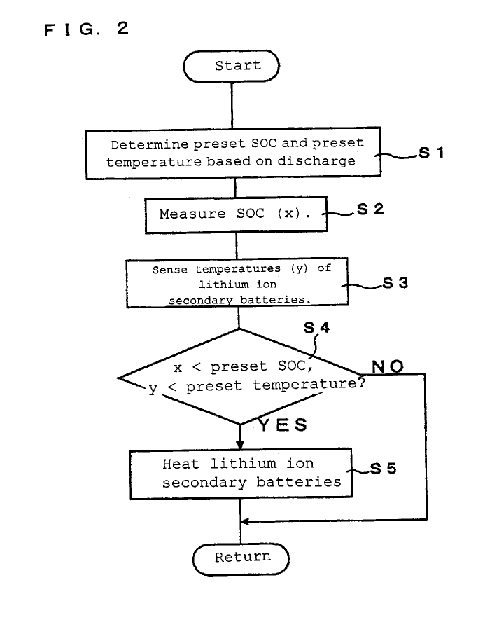

Next, a detailed description will be given on the operation of the lithium ion secondary battery system of FIG. 1, with reference to FIG. 2.

In the lithium ion secondary battery system which is shown, first, the preset SOC and the preset temperature are determined in association with the discharge rate designated depending on the characteristics of the loading device 15, power of which is supplied from the battery pack 10. That is, the preset SOC and the preset temperature are designated in advance from the aspects of experiment or design, to serve as three-dimensional data ((x, y, z)=(preset SOC, preset temperature, discharge rate)) in association with discharge rate. These set values are stored in advance in the memory unit 22 (step S1).

Next, the switching device for discharge (not shown) is turned ON, and thus: discharge is started in a predetermined discharge circuit, beginning from the battery pack 10; and supplying of power to the loading device 15 is also started. At the same time with the start of discharge, SOC measurement of the lithium ion secondary batteries is started by the SOC measuring unit (step S2). Also, temperature sensing of the lithium ion secondary batteries is also started by the temperature sensing unit (step S3). The order in which the steps S2 and S3 are carried out is not particularly limited, and the step S3 may be carried out before the step S2.

The heating control unit 21 sends a command to the heater drive unit 14, commanding that heating of the lithium ion secondary batteries 11 would be carried out, in the case where the measured SOC of the lithium ion secondary batteries 11 is lower than the preset SOC stored in advance in the memory unit 22, and the sensed temperatures of the lithium ion secondary batteries 11 are lower than the preset temperature stored in advance in the memory unit 22 (that is, in the case of YES at step S4). Thus, currents are passed to the heaters 23, and heating of the lithium ion secondary batteries 11 is started (step S6).

A succession of these steps is carried out repeatedly for the duration until the voltage of the lithium ion secondary batteries 11 drops and reaches the discharge cutoff voltage.

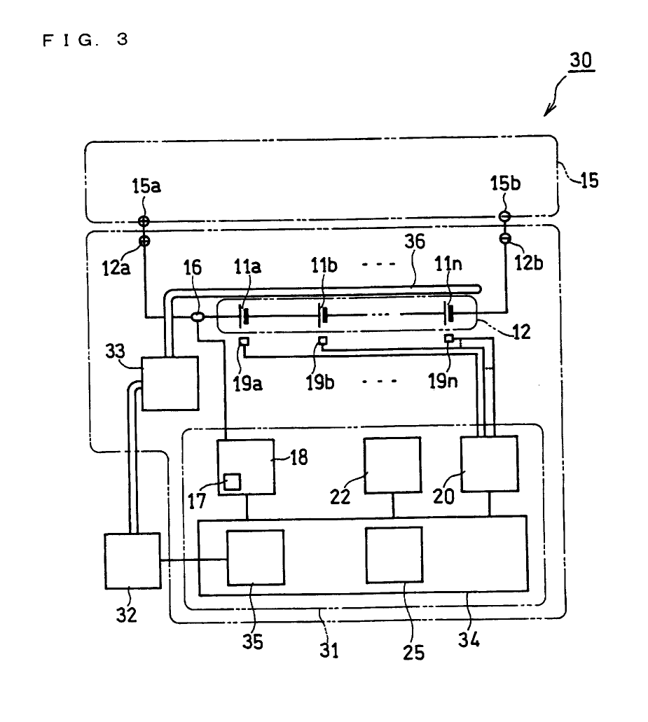

Next, a description will be given on a lithium ion secondary battery system 30 which is installed as a power source for driving a vehicle, as another example of the present embodiment, with reference to FIG. 3.

The lithium ion secondary battery system 30 comprises: an assembled battery 12 including a plurality of lithium ion secondary batteries 11; a battery ECU 31; a loading device 15 connected to the assembled battery 12; and a heating unit including a heat source unit 32. Since a structure with the same reference numerals as FIG. 1 is identical to the structure of FIG. 1, further explanation will be omitted.

The battery ECU 31 includes: a SOC measuring unit, a temperature sensing unit, and a memory unit 22, all being devices similar to those of FIG. 1; and a control unit 34 for controlling the lithium ion secondary battery system 30.

The control unit 34 is, for example, a control circuit provided with an integrated circuit, and includes a heating control unit 35 and a determining unit 25.

The heating unit heats the lithium ion secondary batteries 11, by the amount of heat supplied from the heat source unit 32 which is an external heat source. The heating unit includes a fluid pump 33; and a heat medium conduit 36 which is disposed on the surface or in the vicinity of the lithium ion secondary batteries 11. For the heat source unit 32, residual heat generated by driving a vehicle can be used, for example. Such residual heat is supplied to the heat medium conduit 36 by the fluid pump 33, after heat is accumulated in a heat exchange fluid, such as air, water, or oil. The fluid pump 33 allows the heat exchange fluid to flow between the heat medium conduit 36 and the heat source unit 32 for circulation, by following the command from the heating control unit 35. This enables heating of the lithium ion secondary batteries 11.

The lithium ion secondary battery system 30 shown in FIG. 3 operates in the same manner as the lithium ion secondary battery system 10 shown in FIG. 1, except for differing in terms of using the heat source unit 32, which is outside the battery system, as the heat source for heating the lithium ion secondary batteries 11.

### INDUSTRIAL APPLICABILITY

The present invention is useful for battery systems requiring high current discharge, such as those in electric vehicles, hybrid cars, etc.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

10 battery pack
11 (11a, 11b, 11n) lithium ion secondary battery
12 assembled battery
12a connection terminal
12b connection terminal
13 battery control unit
14 heater drive unit
15 loading device
15a connection terminal
15b connection terminal
16 current sensor
17 timer
18 SOC calculating unit
19a temperature sensor
19b temperature sensor
19n temperature sensor
20 temperature calculating unit
21 heating control unit
22 memory unit
23 (23a, 23b, 23n) heater
25 determining unit
30 lithium ion secondary battery system
32 heat source unit
33 fluid pump
34 control unit
35 heating control unit
36 heat medium conduit

1. A lithium ion secondary battery system comprising:
an assembled battery comprising a plurality of lithium ion secondary batteries each provided with a positive electrode including olivine-based lithium composite phosphate;
a SOC measuring unit for measuring the SOC which indicates the state of charge of at least one of said lithium ion secondary batteries;
a temperature sensing unit for sensing the temperature of at least one of said lithium ion secondary batteries;
a heating unit for heating at least one of said lithium ion secondary batteries; and
a heating control unit for controlling said heating unit to heat said at least one of said lithium ion secondary batteries,
wherein, said heating control unit sends a command to heat said at least one of said lithium ion secondary batteries to a predetermined target temperature, when a measured SOC measured by said SOC measuring unit is lower than a preset SOC set in advance in association with discharge rate, and a sensed temperature sensed by said temperature sensing unit is lower than a preset temperature set in advance in association with said discharge rate.

2. The lithium ion secondary battery system in accordance with claim 1, wherein said preset SOC is 5 to 40% relative to a 100% SOC of a fully charged state of said at least one of said lithium ion secondary batteries.

3. The lithium ion secondary battery system in accordance with claim 1, wherein said preset temperature is 25 to 50° C.

4. The lithium ion secondary battery system in accordance with claim 1, wherein said target temperature is 45 to 55° C.

5. The lithium ion secondary battery system in accordance with claim 1, wherein said olivine-based lithium composite phosphate is represented by the general formula (I): LiₓMe(PO_{y})_{z}, where Me is at least one selected from the group consisting of Na, Mg, Sc, Y, Mn, Fe, Co, Ni, Cu, Zn, Al, Cr, Pb, Sb, and B; 0<x≦2, 3≦y≦4, and 0.5<z≦1.5.

6. The lithium ion secondary battery system in accordance with claim 5, wherein said olivine-based lithium composite phosphate represented by the general formula (1) contains, as Me, two or more elements selected from said group, and 20 mol % or more of Me is Fe.

7. The lithium ion secondary battery system in accordance with claim 1, wherein said heating unit includes a resistor which generates heat by passing current therethrough.

8. The lithium ion secondary battery system in accordance with claim 1, wherein said heating unit uses an external heat source as the heat source.

9. The lithium ion secondary battery system in accordance with claim 8, said system being installed as a power source for driving a vehicle, wherein said external heat source is residual heat generated by driving the vehicle.

10. A battery pack comprising: the lithium ion secondary battery system in accordance with claim 1; and a charge/discharge control unit for controlling charge and discharge of said plurality of the lithium ion secondary batteries.
